(19) United States
(12) Patent Application Publication
(10) Pub. No.: US 2005/0097119 A1
(43) Pub. Date: May 5, 2005

(54) Industrial information technology (IT) paperless operator workstation

(76) Inventors: Deia Salah-Eldin Bayoumi, Fuquay Varina, NC (US); William John Vick, Cary, NC (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/699,376

(22) Filed: Oct. 31, 2003

(51) Int. Cl. G06F 7/00

(52) U.S. Cl. 707/102

(57) ABSTRACT

The present invention provides a system and methods for centrally storing, managing, processing, and visually displaying real-time enterprise manufacturing management and control information across the many cooperating departments of a manufacturing environment. In an illustrative implementation, the present invention comprises an exemplary manufacturing data management and control computing application deployed across the various departments of a manufacturing enterprise through a computing environment having data communications capabilities. The manufacturing data management and control computing application comprises a display area and processing area. The display area comprises a graphical user interface capable of displaying various types of manufacturing and manufacturing related data to participating users. The exemplary manufacturing data management and control computing application processing area comprises a data management and control engine. The data management and control engine operates on a set of predefined data management and control rules to process data for display, communication, and storage.

### FIELD OF THE INVENTION

This invention relates in general to the field of information management. More particularly, the invention relates to a system and method of real-time monitoring, visualization, and control over manufacturing processes and other key business processes.

### BACKGROUND OF THE INVENTION

Managing daily business activities efficiently is very important to keep operating costs low and customers satisified. In today's business world, it is very difficult and complicated to obtain real-time information necessary to manage business processes and monitor assets. Using incomplete or inaccurate data can lead to strategic and tactical mistakes, long lead times, high work in progress (WIP), and quality problems. These problems cost businesses time and money due to higher capital expenses, decreased cash flow through lower inventory turnover, higher saftey/buffer stocks, and decreased availability.

Conventional practices do not provide an efficient, flexible and reliable system to monitor and control the daily, and short and long term activities of an enterprise in real-time. In the context of manufacutring environments, conventional practices rely on extensive manual operations to communicate data between cooperating departments for the manufacture of a particular product. Currently, manufacturing environments are structured such that critical manufacturing data is decentralized and, in most cases, stored in a non-electronic format. As such, manual operations are required to aggregate, process, and communicate manufacturing data between the various cooperating manufacturing departments.

For example, across a manufactruing enterprise, the sales and marketing department working in conjunction with the engineering department may initiate a manufacturing project for the manufacture of a particular product responsive to one or more customer orders. In such case, the engineering department generates product design data and possbily contributes to the generaiton of a project planning and management data for use when manufacturing the product. The engineering design and planning data is then manually (e.g. physically) sent to the manufacturing plant's foreman so that the manufacturing environment may be tooled to manufacture the desired product. The foreman, working in conjunction with the purchasing department and the engineering department, identifies the raw materials for use in manufacturing the product and generates task lists to task various cooperating manufacturing resources (e.g. manufacturing machines). In turn, the manufacturing resources (e.g machine operators), process (e.g. program machines) and execute (e.g. operate the machines) the instructions provided by the manufacturing foreman and engineering department to process various raw and semi-raw materials along the tooled manufacturing assembly line to manufacture and assemble a particular product. From end-to-end, data is commuicated manually, is not stored centrally, and in most cases exists in a non-digital format exposing the manufacturing process to significant errors as data is easliy corruptible and, in some cases, non-persistent from across cooperating departments.

Thus, in view of the foregoing, there is a need for systems and methods that overcome the limitations and drawbacks of existing practices. In particular, there is a need for a manufacturing paperless workstation that provides a centralized data infrastructure allowing data to be stored and communicated electronically and that allows for the sharing of data across a manufacturing enterprise seamlessly protecting the data from corruption and promoting data persistence.

### SUMMARY OF THE INVENTION

The present invention provides a system and methods for centrally storing, managing, processing, and visually displaying real-time enterprise manufacturing management and control information across the many cooperating departments of a manufacturing environment. In an illustrative implementation, the present invention comprises an exemplary manufacturing data management and control computing application deployed across the various departments of a manufacturing enterprise through a computing environment having data communications capabilities. The manufacturing data management and control computing application comprises a display area and processing area. The display area comprises a graphical user interface capable of displaying various types of manufacturing and manufacturing related data to participating users. In addition to displaying data, the exemplary manufacturing data management and control computing application display area is capable of receiving data inputs from participating users for processing and/or communication. The exemplary manufacturing data management and control computing application processing area comprises a data management and control engine. The data management and control engine operates on a set of predefined data management and control rules to process data for display, communication, and storage.

In operation, the exemplary manufacturing data management and control computing application is interfaced by a participating user (e.g. machine operator). The exemplary computing application communicates with cooperating data resources and other cooperating systems to obtain relevant manufacturing data for presentation to the participating user. Specifically, depending on the task the operator wishes to realize (e.g. manufacturing job he/she wishes to run on a particular manufacturing resource), the operator chooses from a list of options provided by the exemplary computing application. Responsive to the participating user's selection, the exemplary manufacturing data management and control computing application retrieves from cooperating data stores and from other cooperating systems (e.g. enterprise resource planning system, quality system, manufacturing control system, etc.) data (e.g. engineering drawings, job instructions, materials being used, etc.) relevant to the participating user's selection (e.g. task). Moreover, the exemplary manufacturing data management and control communicates with manufacturing resources (e.g. machines) to provide those manufacturing resources with control instructions that when executed realize the participating user's task. As those instructions are being executed, the exemplary manufacturing data management and control computing application monitors the operation of the cooperating manufacturing resources and processes such operational data for display to the participating users through the display area of the exemplary manufacturing data management and control computing application. Additionally, the exemplary manufacturing data management and control computing application is capable of storing on and retrieving from cooperating data stores historical data representative of previously requested tasks. Moreover, the exemplary manufacturing data management and control computing application provides controls to participating users through the described graphical user interface of its display area to perform quality control operations and task management operations. In the context of quality control, operational and status data from the cooperating manufacturing resources is received by the exemplary manufacturing data management and control application and is processed such to notify cooperating quality control systems of any malfunctions or breakages in the manufacturing resources.

The exemplary data management and control application may reside across one or more cooperating computing environments comprising personal computers, a computer network, personal digital assistants, wireless computing elements, and on control units on manufacturing resources.

Additional features and advantages of the invention will be made apparent from the following detailed description of illustrative embodiments that proceeds with reference to the accompanying drawings.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram showing an exemplary computing environment in which aspects of the invention may be implemented;

FIG. 1A is a block diagram of an exemplary manufacturing data management and control computing application environment;

FIG. 1B is a block diagram of a an exemplary computing environment which may support the execution of an exemplary manufacturing data management and control computing application;

FIG. 2 is a block diagram of an exemplary architecture and components of the herein described systems and methods;

FIG. 3 is a block diagram of an illustrative implementation of the architecture described in FIG. 2;

FIG. 4 is a block diagram of an exemplary graphical user interface capable of displaying and receiving manufacturing management and operation data;

FIG. 5 is a flow diagram of the processing performed to realize manufacturing data management and control operations.

### DETAILED DESCRIPTION OF AN ILLUSTRATIVE IMPLEMENTATION

Overview

Current manufacturing practices rely on the manual communication and execution of decentralized data and instructions. Specifically, data generated in one department is often created in non-electronic formats and is communicated manually to other cooperating departments. Such practice is extremely inefficient and error-prone. As data is generated and communicated between the various parties in the manufacturing stream, it may be subject to revisions and modifications. However, under current practices, it is left to the parties to ensure that the most current data is being communicated and processed. Such practice can be disastrous if data is not properly updated leading to the manufacture of a product having incorrect specifications and/or tolerances. Moreover, under current practices, since data is non-centralized, persistence of data across the cooperating manufacturing enterprise departments is rendered a difficult task. Specifically, each department is generally charged with tracking and storing its own data. Furthermore, under current practices instruction execution is rendered very inefficient. As most manufacturing environments do not have electronic control over manufacturing resources, manufacturing resource operators are left with the task of inputting various data (e.g. specification, tolerance, raw materials data) required for component or product manufacturing.

The herein described systems and methods ameliorate the shortcomings of existing practices by providing a centralized data infrastructure and user interface that allows for the seamless communication of manufacturing management and control data between various departments of a manufacturing enterprise. In an illustrative implementation, the herein described systems and methods offer a paperless workstation for use in a manufacturing environment by operators of manufacturing resources. The workstation has a graphical user interface that is capable of displaying data and receiving instructions from participating manufacturing resource operators. Additionally, the workstation comprises a data processing engine that operates on rules for data management and control.

In operation, a participating operator interfaces with the workstation to identify a particular task or set of tasks to be performed by one or more of the manufacturing resources. Such information is inputted to the workstation via the graphical user interface and is processed such that the appropriate departments receive or are notified of the task to be performed. Furthermore, the manufacturing resources are provided, electronically, operation instructions so that a component or product can be manufactured by the tasked manufacturing resource. As the manufacturing resource operates, data is communicated back to the workstation for processing. The operations data is displayed to the participating manufacturing resource operator so that he/she can monitor the activities of the cooperating manufacturing resources. Should a problem arise, the workstation notes the problem and communicates such information to the appropriate department(s) according to some predefined manufacturing data management and control rules.

It is appreciated that although the herein described systems and methods are presented having a particular configuration and composition, that the such presentation is merely exemplary as the herein described systems and methods may be configured and composed in various manners to achieve the herein described functions and operations.

Exemplary Computing Environment

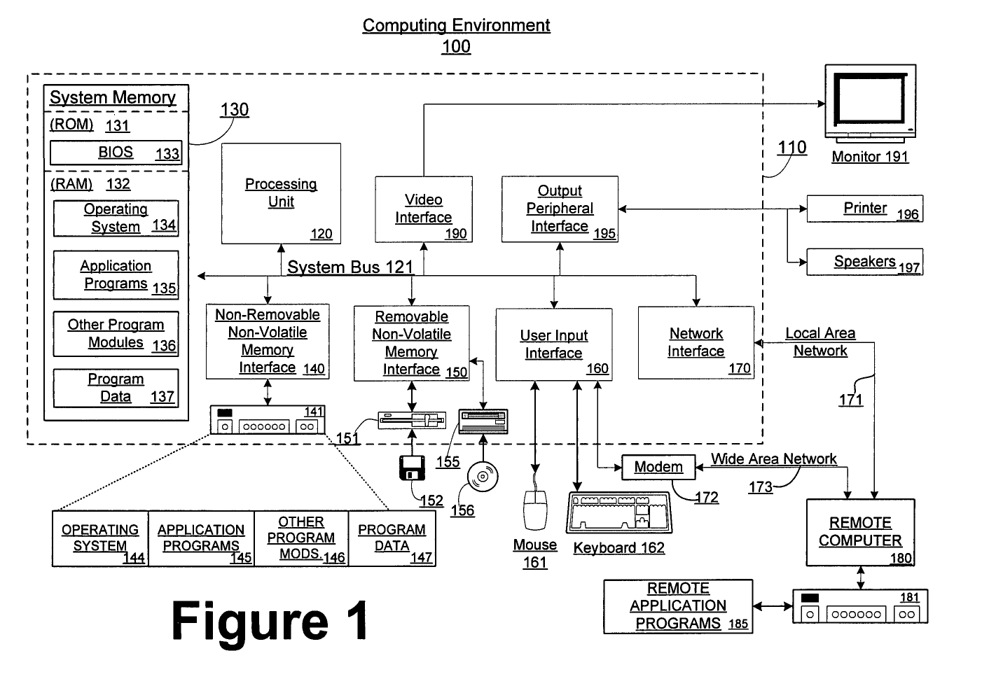

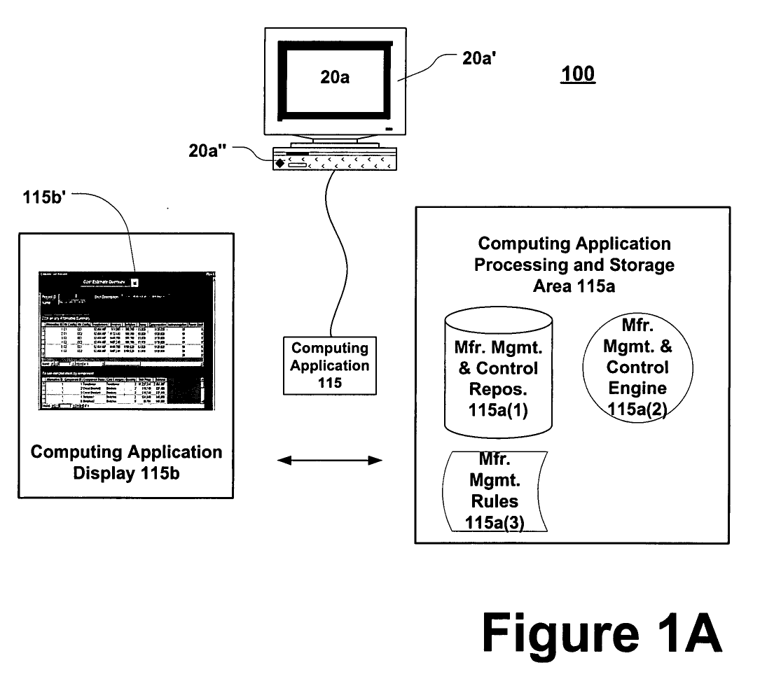

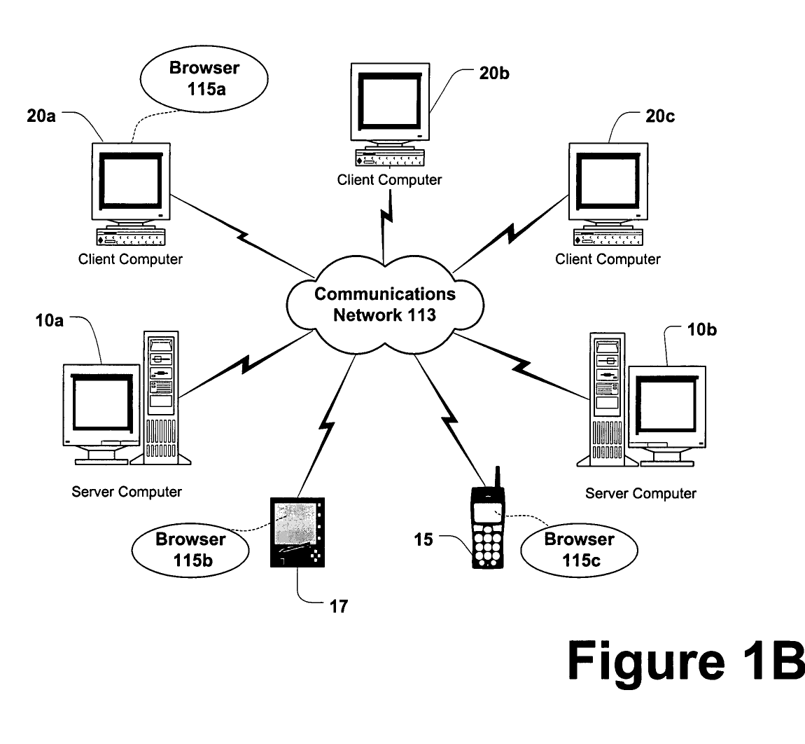

FIG. 1 illustrates an example of a suitable computing system environment 100 in which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network or other data transmission medium. In a distributed computing environment, program modules and other data may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and non-volatile media, removable and non-removable media. By way of example, and not limitation, computer readable media may comprise computer storage media and communication media. Computer storage media includes both volatile and non-volatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or non-volatile memory such as ROM 131 and RAM 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/non-volatile computer storage media. By way of example only, FIG. 1 illustrates a hard disk drive 141 that reads from or writes to non-removable, non-volatile magnetic media, a magnetic disk drive 151 that reads from or writes to a removable, non-volatile magnetic disk 152, and an optical disk drive 155 that reads from or writes to a removable, non-volatile optical disk 156, such as a CD-ROM or other optical media. Other removable/non-removable, volatile/non-volatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

FIG. 1A shows additional components of computing system 100 that may support the present invention. Computing system 100 further comprises computer 20a that may comprise display device 20a′ and interface and processing unit 20a″. Computer 20a may support computing application 115. As shown, computing application 115 may comprise computing application processing and storage area 115 and computing application display 115b. Computing application processing and storage area 115a may contain manufacturing management and control repository 115a(1), manufacturing management and control engine 115a(2), and manufacturing and management rules 115a(3). Similarly, computing application display 115b may comprise display content 115b′. In operation, a participating user (not shown) may interface with computing application 115 through the use of computer 20a. The participating user (not shown) may navigate through computing application 115 to input, display, and generate data representative of manufacturing processes. Manufacturing process instructions and data be created by computing application 115 using the manufacturing management and control repository 115a(1), manufacturing management and control engine 115a(2), and manufacturing management and control rules 115a(3) of computing application processing and storage area 115a and shown to a participating user (not shown) as display content 115b′ on computing application display 115b.

Computer 20a, described above, can be deployed as part of a computer network. In general, the above description for computers applies to both server computers and client computers deployed in a network environment. FIG. 1B illustrates an exemplary network environment, with a server in communication with client computers via a network, in which the present invention may be employed. As shown in FIG. 1B, a number of servers 10a, 10b, etc., are interconnected via a fixed-wire or wireless communications network 113 (which may be a LAN, WAN, intranet, the Internet, or other computer network) with a number of client computers 20a, 20b, 20c, or computing devices, such as, mobile phone 15, and personal digital assistant 17. In a network environment in which the communications network 113 is the Internet, for example, the servers 10 can be Web servers with which the clients 20 communicate via any of a number of known communication protocols, such as, hypertext transfer protocol (HTTP) or wireless application protocol (WAP). Each client computer 20 can be equipped with browser 115a to gain access to the servers 10. Similarly, personal digital assistant 17 can be equipped with browser 115b and mobile phone 15 can be equipped with browser 115c to display and receive various data.

In operation, a participating user (not shown) may interact with a computing application running on a client computing devices to obtain and generate manufacturing data management and control information and instructions for discrete manufacturing environments. The instructions and information may be stored on server computers and communicated to cooperating users through client computing devices over communications network 113. A participating user may create, track, manage, and store manufacturing instructions and information by interfacing with computing applications on client computing devices. These transactions may be communicated by client computing devices to server computers for processing and storage. Server computers may host computing applications for the processing of manufacture process information relevant to discrete manufacturing environments.

Thus, the present invention can be utilized in a computer network environment having client computing devices for accessing and interacting with the network and a server computer for interacting with client computers. However, the systems and methods providing manufacturing management and control instructions and information as described by the systems and methods disclosed herein can be implemented with a variety of network-based architectures, and thus should not be limited to the example shown. The systems and methods disclosed herein will be described in more detail with reference to a presently illustrative implementation.

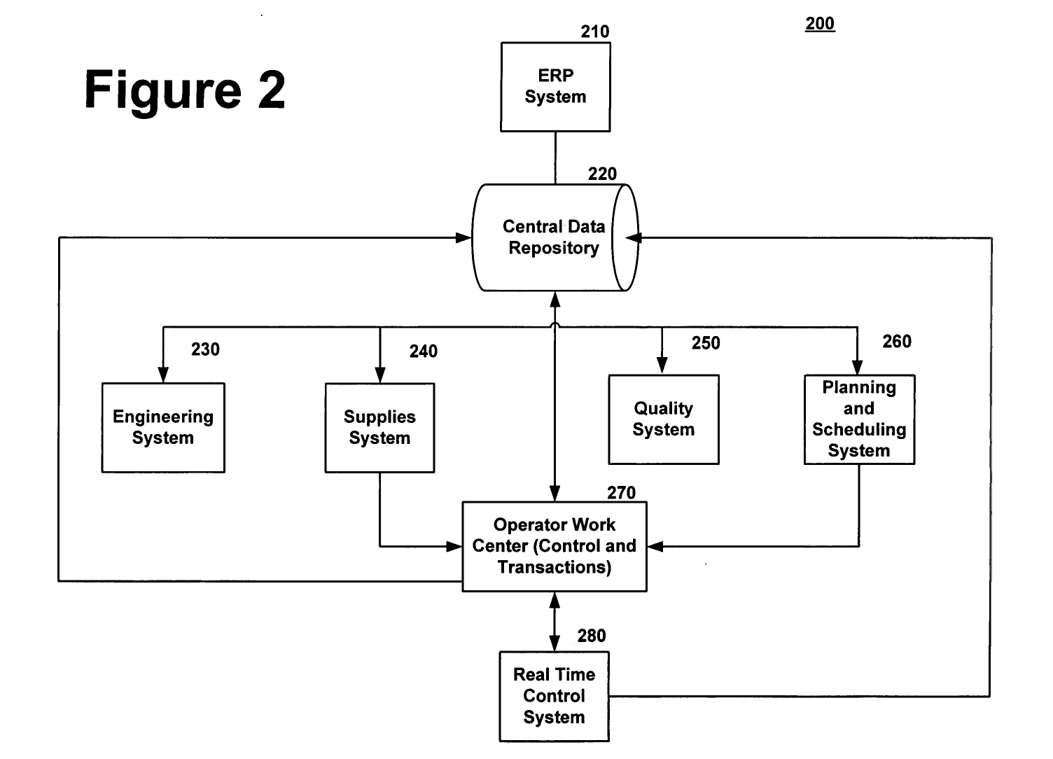

FIG. 2 shows an exemplary architecture for the various cooperating components of an exemplary manufacturing data management and control system 200. As is shown, manufacturing data management and control system 200 comprises enterprise resource planning system 210, central data repository 220, engineering system 230, supplies system 240, quality system 250, and planning and scheduling system 260. Manufacturing data management and control system 200 further comprises operator work center 270 and real time control system 280.

In operation, manufacturing data management and control system 200 and its components are populated with data representative of various manufacturing projects. Such data may comprise, engineering data, planning and scheduling data, quality data, and supplies data. A participating operator (not shown) may interface with manufacturing data management and control system 200 using operator work center 270. In such case, an operator may input instructions to start one or more jobs on cooperating manufacturing resources (not shown) to begin the production of a product or product component. Responsive to such input, real time control system 280 retrieves data from central data repository 220 relevant to the inputted jobs. Furthermore, work center 270 communicates with and cooperates with engineering system 230, supplies system 240, quality system 250 and planning an scheduling system 260 to obtain additional engineering, planning, quality, and supplies related data for the inputted jobs. Such engineering, supply, quality, and planning and scheduling data is communicated from these various subsystems to central data repository 220 for storage purposes. Additional data may be provided by ERP system 210, whose data is stored in central data repository 220. Work center 270 processes all of the retrieved data for display to the participating operator (not shown). The participating operator may then initiate the job by communicating data to real time control system 280 which in turn processes the job command to generate instructions for cooperating manufacturing resources (not shown).

Furthermore, as a job is being processed, real time control system 280 monitors the cooperating manufacturing resources to ensure that the inputted job(s) is/are being executed correctly. Should a problem arise, real time control system 280 communicates with the work station the nature of the problem such that appropriate decisions may be made by the participating operator (e.g. whether to stop the job, divert resources, etc.). Data about the job execution is also stored in central data repository 220 for historical and analytical purposes.

In having all of the data stored in the central data repository the participating operator is capable of accessing various relevant information for the job or task to be executed on the fly and in real time.

It is appreciated that although exemplary manufacturing data management and control system 200 is presented having a particular configuration and comprising particular components such presentation is merely illustrative as the herein described systems and methods may have various configurations comprising various components.

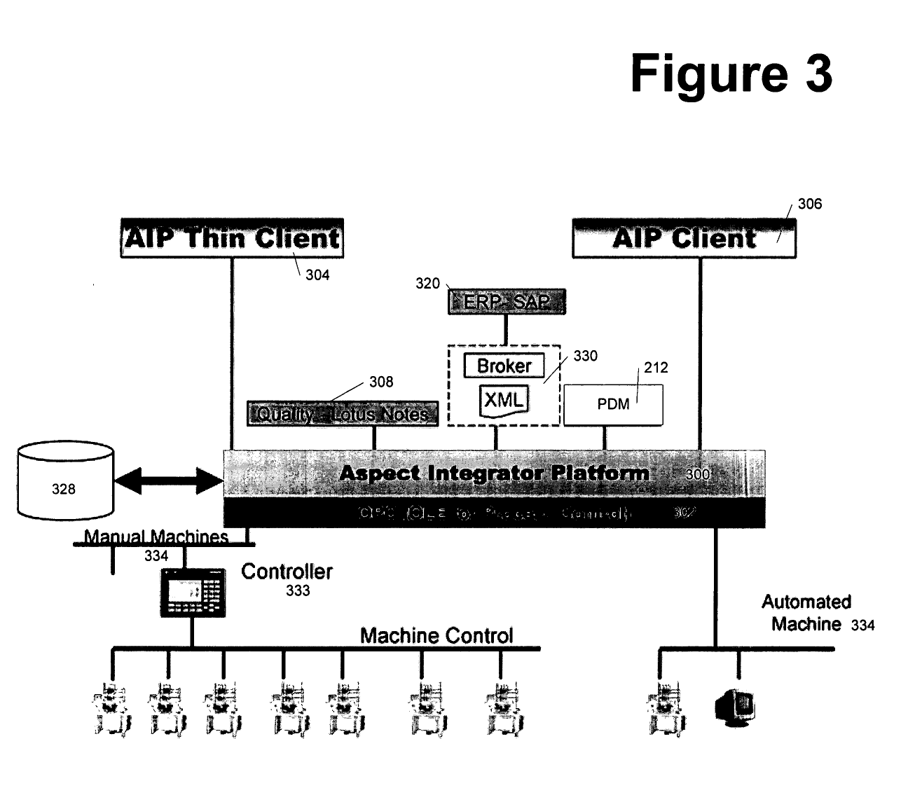

In an illustrative implementation, the herein described systems and methods have a component for data collection that includes sensors and barcode technology and associated software to collect manufacturing data from shop floor in real time. Referring to FIG. 3, the present invention integrates the disparate manufacturing and information systems into an Application Integrator Platform (AIP) platform 300. The AIP platform 300 may be implemented on a computer similar to computer 110 and receive data from several systems and to provide visual monitoring. The AIP is platform independent, and may be implemented using VB coding standards, JAVA, C++ or within a .Net Environment. If the platform 300 needs financial information, the data may be extracted from an Enterprise Resource Planning (ERP) system 220 via an exchange of XML data 330 in real-time. The common visualization program enables the sharing of business and manufacturing content and data across the enterprise by supporting integration to Enterprise Resource Planning (ERP) system 320 via an exchange of XML data 330 in real-time for financial information or to other enterprise applications such as Quality, Manufacturing, Execution System (MES) 308, Product Data Management (PDM) 312, etc.

Data related with manufacturing will be gathered from feedback points in the plants using sensors and a barcode system. While sensors will detect a machine on/off status, the barcode system will used to follow the manufacturing order and operator activities. When sensor signals are sent to OPC server 302 by the controller 333, AIP 300 or Web interface will be used to obtain data and display the information to the user. The AIP 300 will also have interface with the SQL database 328, which stores data collected by barcode system. Participating users interact with the system by logging on to the AIP 300 locally, or remotely using a WWW interface via the Internet. In operation, OPS 302 communicates data to manual machines 334 using controller 333 and to directly to automated machines 334.

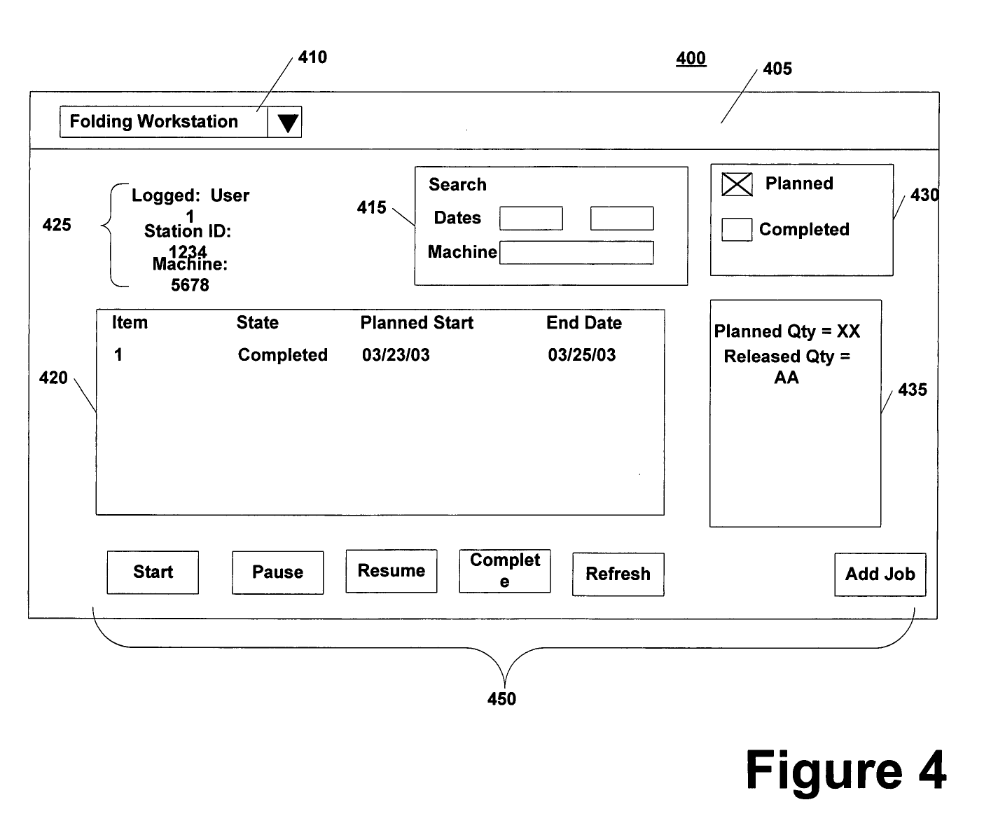

FIG. 4 shows an exemplary graphical user interface (GUI) 400 that may be found on work center 270 of FIG. 2. As is shown GUI 400 comprises various display and input areas 405, 410, 415, 420, 425, 430, 435 and control buttons 450. In operation, a participating user may navigate through GUI 400 using one or more of the display areas and/or controls. Specifically, in an exemplary scenario a participating machine operator is tasked with supervising the production of a transformer winding. The operator logs onto his/her workstation associated with the machine to produce the windings. On the workstation display area, his/her log in information is stored and displayed in display area 425. The operator, not familiar with which type of winding to produce may employ search dialog and display area 415. As is shown, search display area 415 may comprise on or more interactive fields (menus) or dialog boxes which allow participating operators to search data (e.g. data from central data repository 220) to identify the job or product, which the operator is to be supervising. These fields may comprise date search information and/or machine search information. Additionally, participating operator (not shown) may provide an indication of the status of the job in status display and dialog area 430. As is shown, status display and dialog area comprises fields to identify the status of the job (e.g. planned or completed). Once the job begins, the participating operator (not shown) may monitor the status of the job in job/materials detail display areas 420 and 435. The participating operator (not shown) may also directly control the operation of the machines with controls 450 of GUI 400. As is shown, controls 450 allow participating operators to start, pause, resume, and complete the job. Also, controls 450 allow for the refresh of the data displayed in GUI 400 so that more current information can be obtained without waiting for predefine data refreshes. Lastly, the participating user may add new jobs through controls 450.

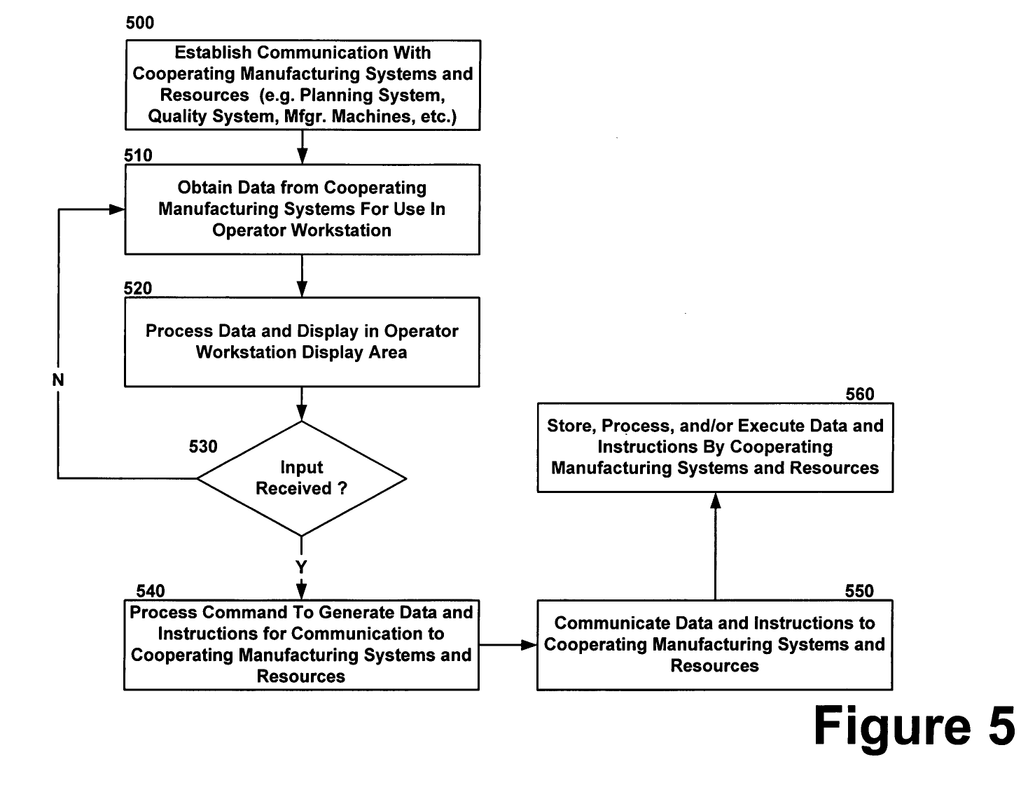

FIG. 5 shows the processing performed by exemplary manufacturing data management and control system. As is shown, processing begins at block 500 where communication is established with the cooperating manufacturing systems and resources (e.g. planning system, quality system, manufacturing machines). From there, processing proceeds to block 510 where data from cooperating manufacturing systems is obtained by the operator workstation (e.g. operator work center). At block 520, the obtained data is processed and displayed in the operator workstation display area. A check is then performed at block 530 to ascertain if any operator input is received. If there is no operator input, processing reverts to block 510 and proceeds there from.

However, if an input is received at block 530, processing proceeds to block 540 where the input (command) is processed to generate data for communication to the cooperating manufacturing systems and resources (e.g. machines). From there processing proceeds to block 550 where the data and instructions are communicated to the cooperating manufacturing systems and resources. The generated instructions and data are then stored, processed, and executed.

In sum, the herein described systems and methods provide a paperless operator workstation for use in discrete manufacturing environments. It is understood, however, that the invention is susceptible to various modifications and alternative constructions. There is no intention to limit the invention to the specific constructions described herein. On the contrary, the invention is intended to cover all modifications, alternative constructions, and equivalents falling within the scope and spirit of the invention.

It should also be noted that the present invention may be implemented in a variety of computer environments (including both non-wirless and wireless computer environments), partial computing environments, and real world environments. The various techniques described herein may be implemented in hardware or software, or a combination of both. Preferably, the techniques are implemented in computer programs executing on programmable computers that each include a processor, a storage medium readable by the processor (including volatile and non-volatile memory and/or storage elements), at least one input device, and at least one output device. Program code is applied to data entered using the input device to perform the functions described above and to generate output information. The output information is applied to one or more output devices. Each program is preferably implemented in a high level procedural or object oriented programming language to communicate with a computer system. However, the programs can be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The system may also be considered to be implemented as a computer-readable storage medium, configured with a computer program, where the storage medium so configured causes a computer to operate in a specific and predefined manner.

Although an exemplary implementation of the invention has been described in detail above, those skilled in the art will readily appreciate that many additional modifications are possible in the exemplary embodiments without materially departing from the novel teachings and advantages of the invention. Accordingly, these and all such modifications are intended to be included within the scope of this invention. The invention may be better defined by the following exemplary claims.

1. A system for management and control of manufacturing processes using an operator workstation comprising:
a manufacturing control and management engine that receives plural types of data from manufacturing and information systems, said application integration platform processing plural types of data to generate manufacturing management and control data for display on the workstation;
a data store containing instructions set for the management and control of manufacturing data and storing manufacturing and control data; and
a graphical user interface that interfaces with said application integration platform and data store to provide a visual display and control over manufacturing processes using the plural types of data.

2. The system as recited in claim 1, wherein the manufacturing control and management engine further communicates with other cooperating manufacturing systems comprising any of enterprise resource planning systems, planning and scheduling systems, supplies systems, engineering systems, and quality systems to obtain the plural types of data.

3. The system as recited in claim 2, wherein the manufacturing control and management engine communicates with the other cooperating manufacturing systems over a communications infrastructure.

4. The system as recited in claim 1, wherein said graphical user interface further provides reports generated in response to user inputs, said user inputs including at least one of: a range of dates, a range of times, a selection of work station, a selection of work center, a selection of work unit, and an employee identifier.

5. The system as recited in claim 4, wherein the graphical user interface further provides controls to participating users to directly control one or more manufacturing resources.

6. The system as recited in claim 5, wherein a work in progress analysis is provided.

7. A system for visually displaying and providing control over manufacturing processes using an operator workstation, comprising:
a manufacturing management and control engine that receives plural types of data from manufacturing and information systems within an enterprise via a network infrastructure and analyzes said plural types of data in response to user inputs;
a database containing said manufacturing data; and
a user interface that displays processed plural types of data to identify manufacturing process status and operations,
wherein the user interface further comprises controls to allow participating users to directly communicate instructions to cooperating manufacturing resources.

8. The system as recited in claim 7, wherein the manufacturing control and management engine communicates with the other cooperating manufacturing systems over a communications infrastructure.

9. The system as recited in claim 7, wherein said graphical user interface further provides reports generated in response to user inputs, said user inputs including at least one of: a range of dates, a range of times, a selection of work station, a selection of work center, a selection of work unit, and an employee identifier.

10. The system as recited in claim 8, wherein the communications infrastructure comprises any of a fixed wire LAN, a wireless LAN, a fixed wire WAN, a wireless WAN, a fixed wire peer-to-peer network, a wireless peer-to-peer network, the Internet, and the wireless Internet.

11. The system as recited in claim 9, wherein the graphical user interface comprises a plurality of display areas capable of displaying one or more features of a manufacturing process.

12. The system as recited in claim 11, wherein the features comprise status information, operator information, materials information, and job progress information.

13. The system as recited in claim 7, wherein the data store is central data repository receiving data from a plurality of cooperating manufacturing systems.

14. The system as recited in claim 7, further comprising a real time control system that couples the graphical user interface with cooperating manufacturing resources, allowing the graphical user interface to have some control over the cooperating manufacturing resource.

15. A method of visually displaying bottleneck information in an enterprise manufacturing system, said method comprising:
obtaining manufacturing management and control data from cooperating manufacturing systems and manufacturing resources;
storing said manufacturing management and control data in a database containing information related to manufacturing processes to be performed in a manufacturing environment; and
presenting manufacturing management and control data to participating users through a graphical user interface, the graphical user interface capable of controlling cooperating manufacturing resources responsive to received data.

16. The method as recited in claim 15, further comprising establishing communications with cooperating manufacturing systems and manufacturing resources.

17. The method as recited in claim 16, further comprising obtaining from cooperating manufacturing systems data relevant to manufacturing processes to be performed in a manufacturing environment.

18. The method as recited in claim 17, further comprising initiating control over a cooperating manufacturing resource.

19. The method as recited in claim 18, further comprising receiving operational data from an operating manufacturing resource about the status of the manufacturing resource for display on the graphical user interface.

20. The method as recited in claim 20, further comprising modifying the operation of the cooperating manufacturing resources depending on the received operational data.
